(19) United States
(12) Patent Application Publication
(10) Pub. No.: US 2018/0316538 A1
(43) Pub. Date: Nov. 1, 2018

(54) TIME VARYING NON-ORTHOGONAL MODULATION

(71) Applicant: Microsoft Technology Licensing, LLC, Redmond, WA (US)

(72) Inventor: Amer Hassan, Kirkland, WA (US)

(73) Assignee: Microsoft Technology Licensing, LLC, Redmond, WA (US)

(21) Appl. No.: 15/582,495

(22) Filed: Apr. 28, 2017

(51) Int. Cl. H04L 27/26

(52) U.S. Cl. CPC H04L 27/2649

(57) ABSTRACT

The implementations allow increases in data rate provided by the Faster-Than-Nyquist multi-carrier signaling to he balanced against system conditions to maintain transmission error rates on channels within an acceptable range. If conditions such as channel traffic load, inter-system interference, intra-system interference, available transmission power, and/or available bandwidth change, the Faster-Than-Nyquist multi-carrier signaling acceleration factor τ used on system channels may be adjusted based on the changing conditions. If conditions change unfavorably, the acceleration factor τ may be increased to lower the data rate so that the error rate improves on the one or more channels. If conditions change favorably, the acceleration factor τ may be decreased to increase the data rate in the improved channel conditions. During system operation, channel conditions may be monitored, and the acceleration factor on the channels may be adjusted to provided higher or lower data rates according to any changes in the channel conditions.

### BACKGROUND

Non-orthogonal transmission schemes can improve spectral-power efficiency as compared to orthogonal transmission schemes by allowing the transmission of an increased number of data symbols within a time period. For example, the non-orthogonal transmission scheme of Faster-Than-Nyquist multi-carrier signaling is a signaling method that may be utilized in future communications systems to increase data rates beyond the data rates provided by current systems such as the widely used current 4G cellular system.

### SUMMARY

This summary is provided to introduce a selection of concepts in a simplified form that are further described below in the Detailed Description. This summary is not intended to exclusively or exhaustively identify key features or essential features of the claimed subject matter. Nor is it intended as an aid in determining the scope of the claimed subject matter.

This disclosure presents embodiments that provide efficient and flexible methods, apparatus, and systems for communicating between devices using time varying Faster-than-Nyquist multi-carrier signals. Use of the methods, apparatus, and systems allows Faster-than-Nyquist multi-carrier signal parameters to be determined and set dynamically based on channel conditions of the network and/or the RF multi-carrier environment in which the communicating devices operate.

An implementation includes a first device for receiving a multi-carrier signal generated using a Faster-than-Nyquist multi-carrier signal acceleration factor that may be dynamically configured. The acceleration factor may be a measure of the increased spectral efficiency obtained by increasing the number of sub-carriers (or sub-channels) in a non-orthogonal multi-carrier signal within a time period. In this implementation, the first device may receive information associated with the Nyquist acceleration factor from a second device through multi-carrier signaling or over a control channel. In an example, the information may comprise a value of the acceleration factor that will be used by the second device for transmissions to the first device. In another example, the information may comprise a function that defines a varying value of the acceleration factor used by the second device as it transmits to the first device. For example, the function may define the acceleration factor over time, or define the acceleration factor over varying values of a system/device parameter. The first device may determine the acceleration factor based on the information received from the second device, receive a multi-carrier signal from the transmitter, and demodulate the multi-carrier signal using the acceleration factor. The first device may also provide feedback information related to performance of the multi-carrier signal transmission to the second device.

An implementation also includes the second device for transmitting the Faster-than-Nyquist multi-carrier signal to the first device, where the Faster-than-Nyquist multi-carrier signal may be dynamically configured as described above. In this implementation, the second device may determine information associated with an acceleration factor to be used for transmissions to the first device. In an example, the information may be a value of the acceleration factor that will be used by the second device for transmissions to the first device. In another example, the information may comprise a function that defines a varying value of the acceleration factor that will be used by the second device as it transmits to the first device. The second device may then communicate the information associated with the acceleration factor to the first device. The second device may also dynamically adjust the acceleration factor based on feedback from the first device and communicate the information associated with the adjusted acceleration factor to the first device.

In another implementation, the acceleration factor/information on the acceleration factor that determines the number of carriers in a multi-carrier signal between a first and a second device may be determined by an apparatus such as a proxy entity separate from the first or second device. The proxy entity may be implemented, for example, as an apparatus configured in infrastructure in the cloud or as an apparatus included in a server residing on a corporate internet. In this implementation, characteristics/parameters on a channel between the first and second devices may be monitored and/or probed, by the apparatus of the proxy entity. For example, the first device and/or second device may send measured parameters associated with the multi-carrier signal on the channel to the proxy entity. The apparatus may determine and provide the acceleration factor/information on the acceleration factor to each of the first and second devices based on the measured parameters. The apparatus may also provide information to the first and second devices related to the structure of the demodulator, such as the trellis state diagram that can be used for decoding the faster-than-Nyquist multi-carrier signal.

A further implementation includes a device that initially receives and demodulates a multi-carrier signal using a first acceleration factor, where the first acceleration factor may be adjusted. The first acceleration factor may be selected based on an initial acceleration Factor that is stored in device memory, or that is selected based on channel conditions of the network and/or the RF environment in which the first device operates. As the first device demodulates and processes the multi-carrier signal using the first acceleration factor, the first device determines a parameter associated with the demodulated multi-carrier signal. For example, the parameter may be a data error rate or other channel quality indicator. The first device determines if the parameter meets selected criteria. For example, the first device may determine if the channel quality indicator is within an acceptable range of values. If the parameter meets the criteria, the first device may continue to receive and demodulate the multi-carrier signal using the first acceleration factor. If the parameter does not meet the criteria, the first device may determine a second acceleration factor and receive and demodulate the multi-carrier signal using the second acceleration factor.

As the first device demodulates and processes the multi-carrier signal using the second acceleration factor, the first device may determine a second parameter associated with the demodulated multi-carrier signal and determine if the second parameter meets the criteria. If the second parameter meets the criteria, the first device may continue to receive and demodulate, the multi-carrier signal using the second acceleration factor. If the second parameter does not meet the criteria, the first device may then determine a third acceleration factor. The first device may repeat the process of demodulating the multi-carrier signal using the third acceleration factor and, if necessary, using successively different acceleration factors, and determining if a parameter associated with the multi-carrier signal demodulated using the third acceleration factor (or one of the successively different acceleration factors) meets the criteria, until an acceleration factor is found that results in the parameter meeting the criteria. The first device may then receive and demodulate the multi-carrier signal using the appropriate acceleration factor, and continue to monitor the parameter associated with the demodulated multi-carrier signal. The first device may adjust the acceleration factor again, if necessary, to keep the parameter associated with the demodulated multi-carrier signal meeting the selected criteria.

### BRIEF DESCRIPTION OF THE DRAWINGS

FIG. 1 is a diagram illustrating a system including example devices configured to operate using Faster-than-Nyquist modulation according to the embodiments;

FIG. 2 is a block diagram illustrating portions of the example devices in the system of FIG. 1;

FIG. 3 is a diagram showing an example function for a Faster-than-Nyquist acceleration factor versus time;

FIG. 4A is a flow diagram illustrating operations performed by an example receiver when receiving a Faster-than-Nyquist multi-carrier signal;

FIG. 4B is a flow diagram illustrating operations performed by an example transmitter when sending a Faster-than-Nyquist Multi-carrier signal;

FIG. 5A is a flow diagram illustrating operations performed by another example receiver when receiving a Faster-than-Nyquist multi-carrier signal;

FIG. 5B is a flow diagram illustrating operations performed by a further example receiver when receiving a Faster-than-Nyquist multi-carrier signal;

FIG. 6 is a block diagram illustrating portions of an example device for receiving a Faster-than-Nyquist multi-carrier signal;

FIG. 7 is a flow diagram illustrating example operations performed by the device of FIG. 6 when receiving a Faster-than-Nyquist multi-carrier signal;

FIG. 8 is a simplified block diagram showing an example device configured for receiving a Faster-than-Nyquist multi-carrier signal; and,

FIG. 9 is a simplified block diagram showing an example base station configured for transmitting a Faster-than-Nyquist multi-carrier signal.

### DETAILED DESCRIPTION

The system, method and apparatus will now be described by use of example embodiments. The example embodiments are presented in this disclosure for illustrative purposes, and not intended to be restrictive or limiting on the scope of the disclosure or the claims presented herein.

The technologies and techniques that are described herein provide implementations of systems, methods and apparatus that utilize non-orthogonal multi-carrier signaling in an adaptable and efficient way. The implementations provide the advantages of non-orthogonal transmission schemes that improve spectral-power efficiency as compared to orthogonal transmission schemes by allowing the transmission of an increased number of data symbols within a time period. The implementations also provide a non-orthogonal transmission scheme that is dynamically adapted for use in a practical system device environment in which system conditions may affect the non-orthogonal transmission scheme negatively.

In the implementations described, the non-orthogonal transmission scheme of Faster-Than-:Nyquist multi-carrier signaling may be used. Faster-Than-Nyquist multi-carrier signaling is a multi-carrier signaling method that may be utilized in future communications systems to increase data rates beyond the data rates provided by current systems such the current 4G cellular system.

The current 4G cellular system, which is known as Long-Term Evolution (LTE), has been released and is in commercial service in many countries. In LTE, the peak data rate in the downlink and the uplink has increased to approximately 300 Mbps and 75 Mbps, respectively. LTE supports only packet transmission mode. All data and voice services are provided in the packet domain. LTE uses intra-orthogonal radio access schemes and Orthogonal Frequency Division Multiple Access (OFDMA) was adopted for the downlink, while Single Carrier (SC)-FDMA is used for the uplink.

LTE-Advanced has been developed based on the original LTE radio interface, and various technologies to increase the data rate and spectrum efficiency have been specified. For example, carrier aggregation techniques, enhanced downlink and uplink multiple input multiple output (MIMO) techniques, and inter-cell interference coordination techniques far homogeneous and heternetworks have been specified as techniques to increase data rates. However, because use and traffic demands on LTE and other cellular systems are forecasted to increase greatly, the ability to increase data rates is continually pursued. While technical progress has resulted in increased data rates, it has been proposed that Faster-Than-Nyquist multi-carrier signaling techniques be used to provide further increases in data rates in 4G or 5G systems.

In Faster-Than-Nyquist multi-carrier signaling an acceleration factor is used when transmitting to increase the number of pulses sent in a time period as compared to orthogonal transmission schemes. For example, the below multi-carrier signal equation for Faster-Than-Nyquist Multi-Carrier signaling includes the acceleration factor of τ, where τ<1.

s(t)=\sqrt{Eₛ}Σₙaₙh(t−nτT)
where τ<1.

Normally, in orthogonal multi-carrier signaling the acceleration factor of τ is not present in the multi-carrier signal equation and the factor nT is always an integer. This keeps successive transmitted pulses orthogonally spaced relative to one another. In Faster-Than-Nyquist multi-carrier signaling, the value of τ is set to a value less than 1 to generate a larger number of multi-carrier signal pulses within a time period as compared to orthogonal transmission schemes, and therefore the symbol/data rate is increased. For example, if τ is set to a value of 0.75, the number of pulses in a time period is increased by a factor of 1/0.75. As the value of τ is decreased, pulses are more closely spaced together and the data rate increases. However, the multi-carrier signal pulses may be overlapping in time and the transmission quality of non-orthogonal multi-carrier signaling may be more difficult to maintain as compared to orthogonal transmission schemes. The configuration of a receiver used for Faster-Than-Nyquist multi-carrier signaling may need to be more complex and may be more sensitive to changes in system conditions.

In the implementations described herein, the Faster-Than-Nyquist multi-carrier signaling may be utilized to improve the spectrum efficiency of a system by increasing transmission efficiency the number of symbols transmitted on channels in the system, while at the same time dynamically adapting the Faster-Than Nyquist multi-carrier signaling for changing system conditions. The implementations allow increases in the number of symbols transmitted within a time period, that are provided by the Faster-Than-Nyquist multi-carrier signaling, to be balanced against system conditions to maintain transmission error rates and/or maintain a desired quality of service (QoS) on system channels within a desired or acceptable range. If conditions such a channel traffic load, inter-system interference, intra-system interference, available transmission power, and or available bandwidth change, the Faster-Than-Nyquist multi-carrier signaling acceleration factor τ used on one or more system channels may be adjusted based on the changing conditions. If channel conditions change unfavorably, the acceleration factor τ may be increased to lower the data rate so that QoS remains acceptable on the one or more channels. If channel conditions change favorably, the acceleration factor τ may be decreased to increase the data rate and/or improve QoS to take advantage of the improved channel conditions. During system operation, channel conditions may be monitored, and the acceleration factor τ on the one or more channels may be adjusted to provide higher or lower data rates and maintain an acceptable QoS in response to any changes in the channel conditions.

Receivers and transmitters according to the implementations described may be implemented in any type of communications system. The implementations described have use for any type of communication link/radio channels that may support Faster-than-Nyquist multi-carrier signaling.

In an implementation, a transmitting device sending a Fasten-Than-Nyquist multi-carrier signal to a receiving device may determine an acceleration factor τ to use for the multi-carrier signal and send information about the acceleration factor τ to the receiving device. The information may comprise the acceleration factor τ itself or a function τ(p), where p is a parameter, defining the acceleration factor. This provides an advantage in that the transmitting device may determine the acceleration factor in order to balance a desired data rate against data error rates that may occur on the channel of interest. The acceleration factor τ may be determined based on appropriate data such as historical information on data error rates associated with various acceleration factors used on the channel or by the transmitting device on other channels. The acceleration factor r may also be determined dynamically based on current data error rates on the channel between the transmitting and receiving devices, or on current information based on the activity of other devices in the system. In one example, changes in the acceleration factor τ may be signaled to the receiving device by the transmitting device sending a new value of the acceleration factor τ or sending a revised function that defines the acceleration factor τ to the receiving device.

An implementation in which the transmitting device may send information about the acceleration factor τ to the receiving device would provide an advantage, for example, when a base station in a communication system is the transmitting device. In this scenario, the base station may maintain historical information on acceleration factors and data error rates associated with device operation in its coverage area and utilize the historical information to determine an optimal acceleration factor τ or a function defining an optimal acceleration factor τ for a current situation. For example, the base station may determine an acceleration factor or function based on data relating past data error rates to acceleration factors that have been used by the receiving device or other receiving devices communicating with the base station. The base station may then send the acceleration factor τ or function τ(p) to a receiving mobile device. The base station may also utilize information on interference levels in its RF environment in determining the acceleration factor τ or the function τ(p) defining the acceleration factor. For example, intra-system interference information or information on interference related to time of day may be used. The base station may also utilize information on multiple devices with which it is communicating in determining the acceleration factor τ or the function τ(p) defining the acceleration factor. For example, the base station may assign the acceleration factors or the functions defining the acceleration factors to various mobile devices to which it is transmitting in a coordinated way that takes the effects the mobile device may have on one another's transmissions into account. For example, the function may define the acceleration factor over time, or define the acceleration factor over varying values of a system/device parameter. In another example, the base station may also determine and/or dynamically adjust the acceleration factor or function based on feedback associated with a current data quality of service that is provided by the receiving device as the base station sends the Faster-Than-Nyquist multi-carrier signal to the receiving device. Also, the base station may determine the function that defines the acceleration factor to be used by the base station over time by selecting the function from a database including functions based on past data error rates and past acceleration factors used by the base station. The base station may provide the information associated with the acceleration factor to be used for transmissions to the receiving device, modulate a multi-carrier signal using the acceleration factor according to the information, and send the modulated multi-carrier signal to the receiving device. The receiving device may demodulate the multi-carrier signal using the information associated with the acceleration factor received from the base station.

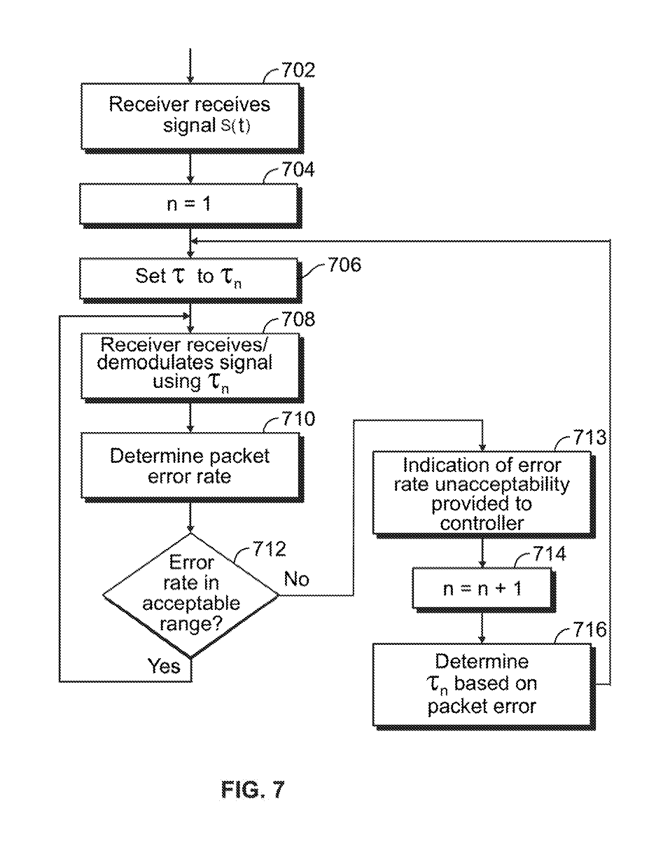

In another implementation, the receiving device does not receive information about the acceleration factor that the transmitting device is using. In this implementation, the receiving device dynamically adjusts the acceleration factor τ used to receive a multi-carrier signal from the transmitting device until the acceleration factor τ in the receiving device matches (or is close enough to) the acceleration factor τ used in the transmitting device, and an acceptable bit error rate is reached. This simplifies aspects of the design of the transmitting device related to controlling the acceleration factor τ used in the receiving device. It also removes the need for back and forth communications regarding the acceleration factor between the transmitting and receiving devices. An example of this implementation is shown and described in relation to FIG. 7.

While the terms “acceleration factor” and “τ” are used in this disclosure to describe particular implementations and configurations, the terms “acceleration factor” and “τ” as used herein are also meant to include and encompass any type of information or parameter that may be used to define/signal a parameter related to the increase or decrease of a number of non-orthogonal pulses of a multi-carrier signal within a time period. The terms “acceleration factor” and “τ” may be used together or each separately in this disclosure to mean the same thing.

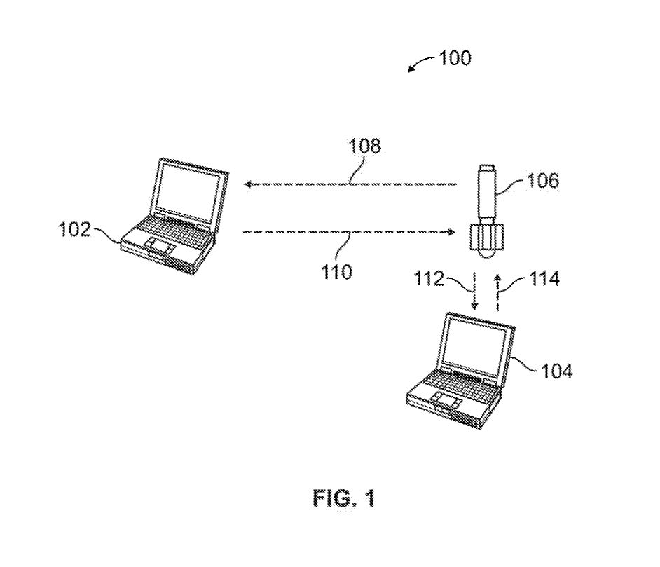

FIG. 1 is a diagram illustrating a system including example devices configured to operate using Faster-Than-Nyquist modulation according to the embodiments. System 100 includes device 102, device 104, and base station 106. In FIG. 1, device 102 is shown transmitting multi-carrier data signals to base station 106 on uplink 110 and receiving multi-carrier data signals from base station 106 on downlink 108. Also, device 104 is shown transmitting multi-carrier data signals to base station 106 on uplink 114 and receiving multi-carrier data signals from base station 106 on downlink 112. Implementations of the disclosure may be described using the example of multi-carrier signals sent on downlink 108 with base station 106 as the transmitting device and device 102 as the receiving device.

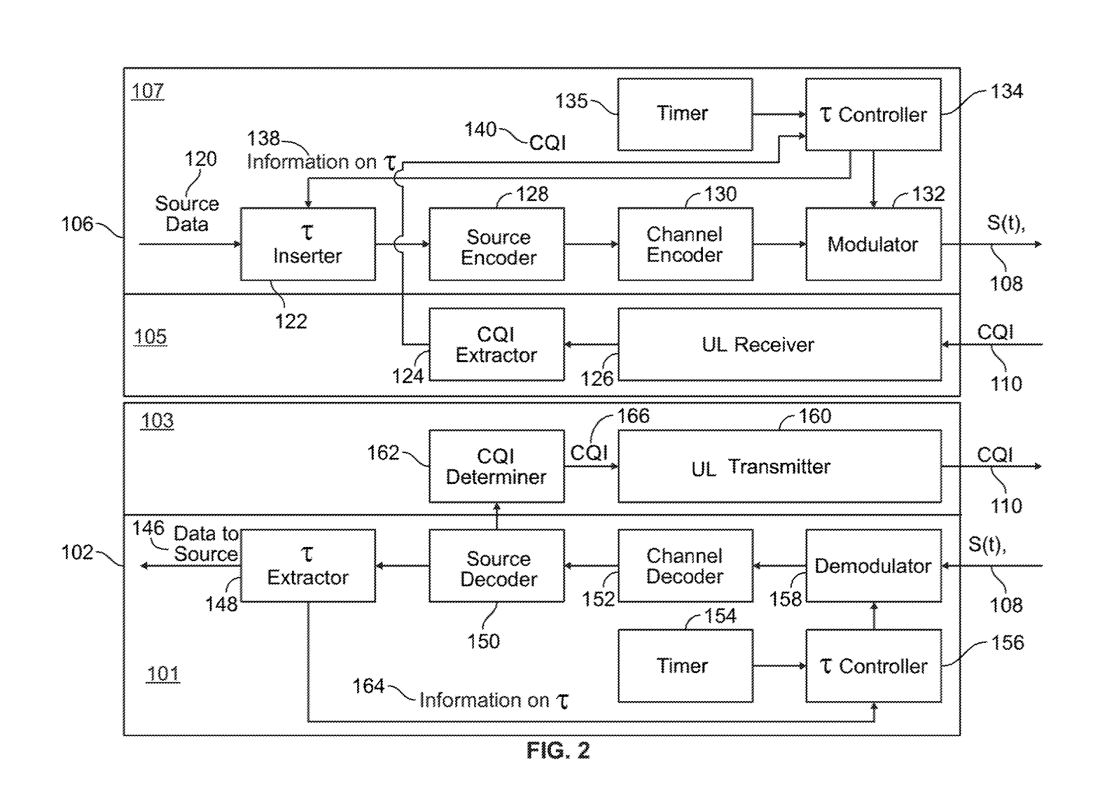

FIG. 2 is a block diagram illustrating portions of the example devices in the system of FIG. 1. FIG. 2 shows portions of the downlink transmitter 107 of base station 106 and of the downlink receiver 101 of device 102. FIG. 2 also shows uplink transmitter portion 103 of device 102 and uplink receiver portion 105 of the receiver of base station 106 that may be used to carry multi-carrier signals for downlink coordination and control. The portions shown in FIG. 2 are related to functions for controlling Faster-Than-Nyquist multi-carrier signaling on downlink 108.

Base station 106 comprises transmitter 107 that includes acceleration factor (τ) controller 134, modulator 132, source encoder 128, channel encoder 130, timer 135, and acceleration factor (τ) inserter 122. FIG. 2 also shows base station 106 including receiver portion 105 comprising uplink. (UL) receiver 126 and channel quality indicator (CQI) extractor 124. Device 102 comprises a receiver 101 that includes acceleration factor (τ) controller 156, demodulator 158, channel decoder 152, source decoder 150, timer 154, and acceleration factor (τ) extractor 148. FIG. 2 also shows device 102 including transmitter portion 103 including uplink (UL) transmitter 160 and channel quality indicator (CQI) determiner 162.

In operation of the example implementation of FIG. 2, the transmitter 107 of base station 106 obtains source data 120 for transmission to device 104 on downlink 108. Source data 120 may be from any type of data source. For example, source data 120 may be from a data source such as an application that is communicating with an application on device 104. Upon obtaining the source data 102, τ inserter 122 inserts information on τ 138 that comprises a value of τ itself or a function τ(p) defining τ, into the source data 120. The information on τ 138 is determined by τ controller 134 and may be provided to τ inserter 122 by τ controller 134. Inserting the information on τ 138 at time intervals into the source data allows base station 106 to signal values of τ being sent to device 102. The source data 120 is then source encoded by source encoder 128 and channel coded at channel encoder 130. Modulator 132 then modulates the encoded data provided by channel encoder 130 using Faster-Than-Nyquist modulation techniques. The modulated multi-carrier signal may be transmitted from transmitter 107 as the multi-carrier signal S(t) on downlink 108. The multi-carrier signal S(t) includes the source data 120 and may also include the information on τ 138 when the information is being sent to device 102. The value of τ used by modulator 132 is obtained from τ controller 134 and may be the same value of τ or based on the same function defining τ that is inserted into the source data by τ inserter 122. Also, during operation UL receiver 126 may receive multi-carrier signals over the uplink 110 from device 102. These received multi-carrier signals may include downlink channel quality information sent by device 102 in the form of one or more channel quality indicators (CQIs). The CQIs may be extracted from the received UL multi carrier signals by CQI extractor 124, and CQI extractor 124 may provide the extracted CQI 140 to τ controller 134. In various implementations, τ controller 134 may determine the value of τ or the function τ(p) defining τ based on the CQI provided by CQI extractor 124 and/or timer values provided by timer 135, τ controller 134 may also include a database that comprises a plurality of values of τ, or a plurality of functions τ(p) defining τ, for different channel conditions/system conditions. In other implementations, τ controller 134 may determine the value of τ or the function τ(p) defining τ based on conditions, such as power available to transmitter 107 for sending S(t), or the amount of bandwidth that is assigned and/or available to transmitter 107 for sending S(t) on downlink 108. The determination of the value of τ or the function τ(p) defining τ may be performed based on one or more of these conditions, alone or in combination. τ controller 134 may control the values of τ used on the downlink 108 so that a lower value of τ is used for conditions in which data rate may be increased, and a higher value of τ is used for conditions in which the data rate may need to be decreased.

In the example implementation of FIG. 2, the receiver 101 of device 102 receives the multi-carrier signal S(t) on downlink 108. Demodulator 158 demodulates S(t) using a value of τ provided by τ controller 156. The demodulated multi-carrier signal is then provided to channel decoder 152 and source decoder 150 for decoding. Source decoder 150 outputs the source data 120 which includes the information on τ inserted into the source data 120 at base station 106. Source decoder 150 provides the decoded data to τ extractor 148, which extracts the information on τ 164 and provides the extracted information on τ 164 to τ controller 156. As the received information on τ 164 received from transmitter 107 changes, r controller 156 may control demodulator 158 so that demodulator 158 demodulates S(t) using the value of τ indicated by base station 106 as currently being used to modulate S(t). Also during operation, UL transmitter 160 may send uplink transmissions to base station 106 on uplink 110. These transmitted multi-carries signals may include downlink channel quality information sent to base station 106 in the form of one or more channel quality indicators (CQIs). CQI determiner 162 may monitor the data output at source decoder 150 to determine the channel quality indicator (CQI) for the Faster-Than-Nyquist modulated multi-carrier signals received by device 102 over downlink 108. CQI determiner 162 may provide the CQI 166 to UL transmitter 160 over time intervals. UL transmitter 160 may then insert the CQI into the transmissions on uplink 110 to base station 106.

The information on τ 138 that is sent from base station 106 to device 102 may comprise the value of τ itself, or a function τ(p) defining the value of τ. For example, the information may be a function τ(p) defining τ over a time period, where the variable p=t, or time. The function τ(p) may also be a function defining τ for varying values of other system/device parameters.

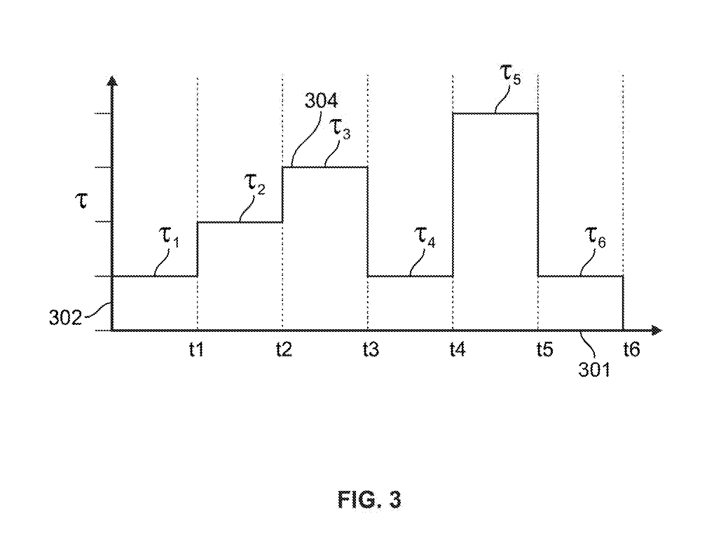

FIG. 3 is a diagram showing an example step function 304 for a Faster-than-Nyquist acceleration factor versus time. Axis 302 shows the value of τ versus time, which is shown on axis 301. Times t1 to t6 each define the end of six time intervals during which the value of τ is set to τ₁ to τ₆, respectively. In an example implementation, when the function of FIG. 3 is sent to device 102 from base station 106, base station 106 will modulate S(t) using τ according to the function and device 102 will demodulate S(t) using τ according to the function.

In FIG. 2, receiver 101 and transmitter 107 are shown implemented in example device 102 and example base station 106, respectively, for downlink communications. In other implementations, receiver 101 and transmitter 107 may be implemented in any type of device. For example, receiver 101 may be implemented in base station 106 and receive Faster-than-Nyquist uplink multi-carrier signals from transmitter 107 implemented in device 102. A communicating device may also include both of receiver 101 and transmitter 107 for sending Faster-Than-Nyquist multi-carrier signals according to the implementations in a bidirectional manner. In further implementations, receivers and transmitters according to the implementations may be implemented in any other type of communications system. The implementations have use for any type of communication link/radio channels that may support Faster-than-Nyquist multi-carrier signaling.

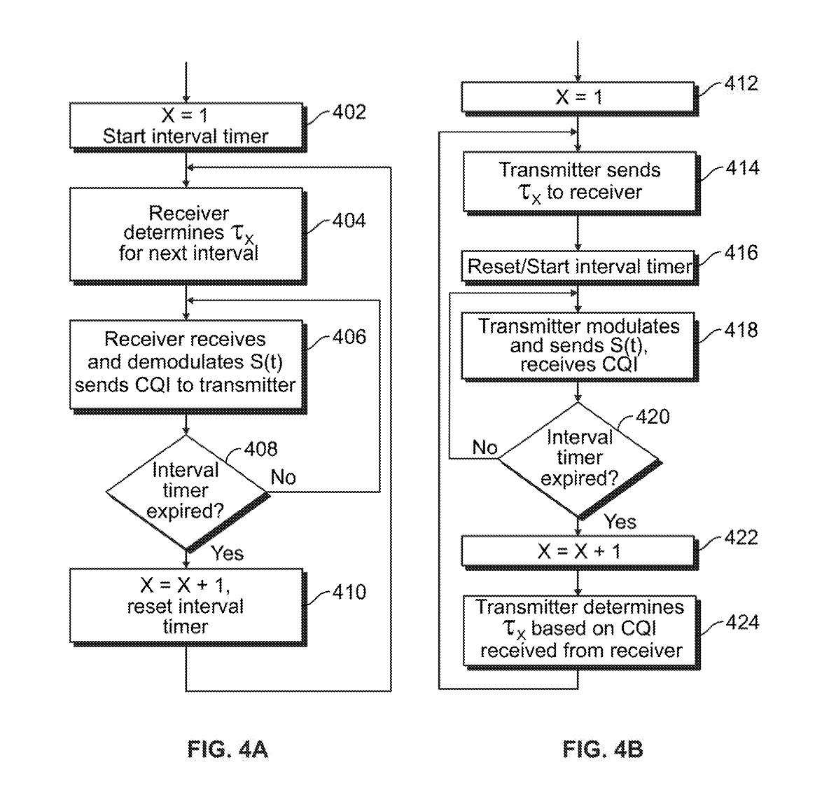

FIG. 4A is a flow diagram illustrating operations performed by a receiver in a device according to an example implementation when receiving a Faster-than-Nyquist multi-carrier signal S(t). The implementation of FIG. 4A may be explained with reference to FIG. 2, using the receiver 101 of device 102 as the example receiver of FIG. 4A.

The process begins at 401, where index X is set to 1 in τ controller 156 and timer 154 is started in receiver 101. The index X indicates the current time interval. For example, when X=1 the interval is interval 1. The timer 154 is used to time the intervals and indicate when each interval expires. The timer 154 may be used to set each interval to last for a selected duration or period of time. For example, when the interval is interval 1 and the timer 154 is started, interval 1 is begun. Then when timer 154 expires, interval 2 is begun and timer 154 is started again. The timer 154 may be used to indicate when receiver 101 may update the value of τ that is used by demodulator 158 to demodulate S(t). When timer 154 indicates that an interval has timed out, receiver 101 will be triggered to update the value of τ for the next interval X. For example, the value of τ may be updated for each interval X of successive intervals, where X=1, X=2 . . . X=N. The time intervals may be predefined, set by negotiation with base station 106, or determined by instructions received from base station 106 that define the time intervals. In one example, the time intervals used by timer 154 may cause the value of τ to be updated periodically. In another example, successive time intervals may vary from one another in duration as time goes on.

At 404, receiver 101 determines the value of τ for interval X. For the initial interval, when X=1 the initial value of τ used may be a default value stored in τ controller 156 or may be a value sent to receiver 101 by transmitter 107 of base station 106 during setup of multi-carrier signal exchanges. τ controller 156 then provides the initial value of τ to demodulator 158 for use in demodulating S(t) during interval. When the interval is not the initial interval and X>1, the value of τ may be a value of t that is determined based on information received from base station 106, as will be explained in reference to subsequent operations of the process.

At 406, receiver 101 receives and demodulates S(t) during interval X. Upon being received, S(t) is demodulated in demodulator 158 using the value of τ determined at 404. Following demodulation, S(t) is channel decoded in channel decoder 152 and also decoded in source decoder 150.

The decoded source data is then sent through τ extractor 148 onward to the application in device 102 that is to receive the source data 120. τ Extractor 148 parses the decoded data and determines if base station 106 has inserted a value of τ into the source data. In an implementation, the value of τ may be sent by the base station 106 once per each interval timed by timer 154. When a value of τ is included in S(t), the value of τ is extracted by τ extractor 148 and provided to τ controller 156. This value of τ may be used by demodulator 158 during the next interval X+1. For example, during interval 1 receiver 101 may receive a value of τ to be used during interval 2.

Also at 406, CQI determiner 162 in device 102 monitors the output of source decoder 150 during the interval X, CQI determiner 162 uses the monitored output of source decoder 150 to determine a channel quality indicator (CQI) of the received multi-carrier signal S(t). The CQI may be a bit error rate, packet error rate, received power level, or any other indicator of the quality of the received multi-carrier signal S(t). Th CQI 166 determined at CQI indicator 162 is provided to UL transmitter 160 and sent to base station 106 on uplink 110. The CQI 166 may be sent to base station 106 periodically as CQI determiner 162 monitors the decoded output of source encoder 150. For example, CQI 166 may be sent once or multiple time during each interval timed by timer 154. Transmitter 107 of base station 106 may use the CQI to determine what value of τ to use for the next interval. The value of τ determined by transmitter 107 may be the value of τ that is sent to receiver 101 in S(t) and extracted in operation 404 by τ extractor 148.

At 408, τ controller 156 determines if timer 154 has expired. If timer 154 has not expired, the process returns to 406. At 406, device 102 continues to receive and decode S(t), extract any values of τ included in S(t), and send CQI 166 to base station 106. τ controller 156 also continues to perform the determination at 408.

However, at 408, it is determined that timer 154 has expired, the process moves to 410. At 410 the index X is incremented to indicate that a new interval has begun. For example, if interval 1 has been timed out, interval 2 begins.

The process moves from 410 to 404 where τ controller 156 of receiver 101 determines the value of τ for the news interval, τ controller 156 may determine the value of τ for the new interval from a value of τ that was received from base station 106 during the previous interval and provided to τ controller 156 by τ extractor 148 during operation 404. Operations 406 and 408 are then repeated using the value of τ for the new interval until the timer 154 indicates that the new interval has expired.

The process repeats through operations 404, 406, 408, and 410 for each new interval based on the interval timer 154. Each time the process repeats, τ is updated at operation 404 and the updated τ is used for the new interval. The value of τ used by demodulator 158 may then be controlled by transmitter 107 of base station 106.

FIG. 4B is a flow diagram illustrating operations performed by an example transmitter in a transmitting device when sending a Faster-than-Nyquist multi-carrier signal S(t). The implementation of FIG. 4B may be explained with reference to FIG. 2, using transmitter 107 of base station 106 as the example transmitter of FIG. 4B that communicates with the receiver of FIG. 4A.

The process begins at 412 where the index X is set to 1 in τ controller 134 and timer 135 is started. The value of the index X in τ controller 134 of base station 106 may be synchronized with the value of the index X in τ controller 156 in devices 102 so that base station 106 and device 102 maintain the same sequence of intervals in both devices. Also, the timer 135 in base station 106 and timer 154 in device 102 may be synchronized to use the same timing for each interval X so the intervals in both devices are consistent with one another. The values of X and the time intervals may be predefined or set by negotiation with device 102. In one example, the time intervals used by timer 135 may be periodic. In another example, the time intervals may vary from one another in duration as the number of durations cycled through increases.

At 414, transmitter 107 sends a value of τ to receiver 101 of device 102. The value of τ sent may be provided by τ controller 134 and may be the value of τ for the current interval (the interval that is beginning). For example, for interval 1, the value of τ sent to receiver 101 is the value of τ that is to be used by receiver 101 when decoding S(t) during interval 1. In an alternative implementation, operation 414 may be omitted on the initial entry in operation 414 when the interval is interval 1. In this implementation, receiver 101 may use a default value or value for τ that was previously negotiated with transmitter 107. In subsequent intervals to interval 1, once a value of τ has been determined based on channel conditions, operation 414 may then be used to send a dynamically adapted τ.

At 416, timer 135 is reset and started to time the next interval. For example, on the first pass through when X=1, timer 135 may be set to run for the period of interval 1.

At 418, transmitter 107 encodes S(t) using the value of τ for the current interval X and sends the encoded multi-carrier signal as S(t) to receiver 101 of device 102. Transmitter 107 may receive source data 120 from a data source such as an application on the base station 106 that is communicating with an application on device 102. In the implementation of FIG. 4B, τ inserter 122 may be bypassed during operation 418 and the source data may be fed into source encoder 128. The source data 120 is then source encoded by source encoder 128 and channel coded at channel encoder 130. Modulator 132 then modulates the encoded data provided by channel encoder 130 using Faster-Than-Nyquist modulation techniques. The modulated multi-carrier signal may be transmitted from transmitter 107 as the multi-carrier signal S(t) on downlink 108. During 418, UL receiver 126 of base station 106 may also receive the CQI 166 sent by UL transmitter 160 of device 102 at 406 of FIG. 4A. The CQI may be extracted by CQI extractor 124 and provided to τ controller 134 as CQI 140.

At 420, τ controller 134 determines if timer 135 has expired. If timer 135 has not expired, the process returns to 418 and transmitter 107 continues to encode and send S(t) to receiver 101. τ controller 156 also continues to perform the determination at 420.

If however, at 420, it is determined that timer 135 has expired, the process moves to 422. At 422 the index X is incremented to indicate that a new interval has begun. For example, if interval 1 has been timed out, interval 2 begins, or if interval 2 has been timed out, interval 3 begins.

The process moves from 422 to 424 where τ controller 134 of transmitter 107 determines the value of τ for the new next interval. τ controller 134 may determine the value of τ based on the CQI information received on the uplink from receiver 101 during the just completed interval. In other implementations, τ controller 134 may also take other factors into account at 424. For example, changes in available transmit power at transmitter 107 or bandwidth available to transmitter 107 may be taken into account in determining the value of τ.

The process then moves to 414 where τ controller of transmitter 107 provides the value of τ determined at 424 to τ inserter 122 and τ inserter 122 inserts the value of τ into source data 120 for encoding in S(t). Transmitter 107 then sends the value of τ to receiver 101. Receiver 101 may then use that value of τ during the next interval. Timer 135 is then again reset at 416.

Operations 418 and 420 may then be repeated using the value of τ that was determined in the last performance of the operation at 424, for the current interval until the timer 135 indicates at 420 that the current interval has expired.

The process than repeats through operations 422, 424, 414, 416, 418, and 420 for each new interval as timed by timer 135. When an interval is timed out, X is incremented and a new interval is begun. Each time the process repeats, τ is updated at operation 414 and the updated value of τ is sent to receiver 101 in S(t). The updated value of τ is then used for the new interval in receiver 101 and transmitter 107 for demodulating and modulating, respectively, the multi-carrier signal S(t).

In another implementation of FIGS. 4A and 4B, instead of transmitter 107 sending values of τ to receiver 101 at operation 414, transmitter 107 may send a function τ(t) that defines the value of τ over a time period. For example., a function τ(t) may be sent from transmitter 107 to receiver 101 for every interval. Transmitter 107 and receiver 101 may then use the function τ(t) for a particular interval to set the value of τ during that interval. In one example, the function τ(t) may be determined by τ controller 134 of transmitter 107 based on the CQI 110 received from receiver 101 for a current interval. The determined function τ(t) may then be sent to receiver 101 for use in setting the value of τ for the next interval.

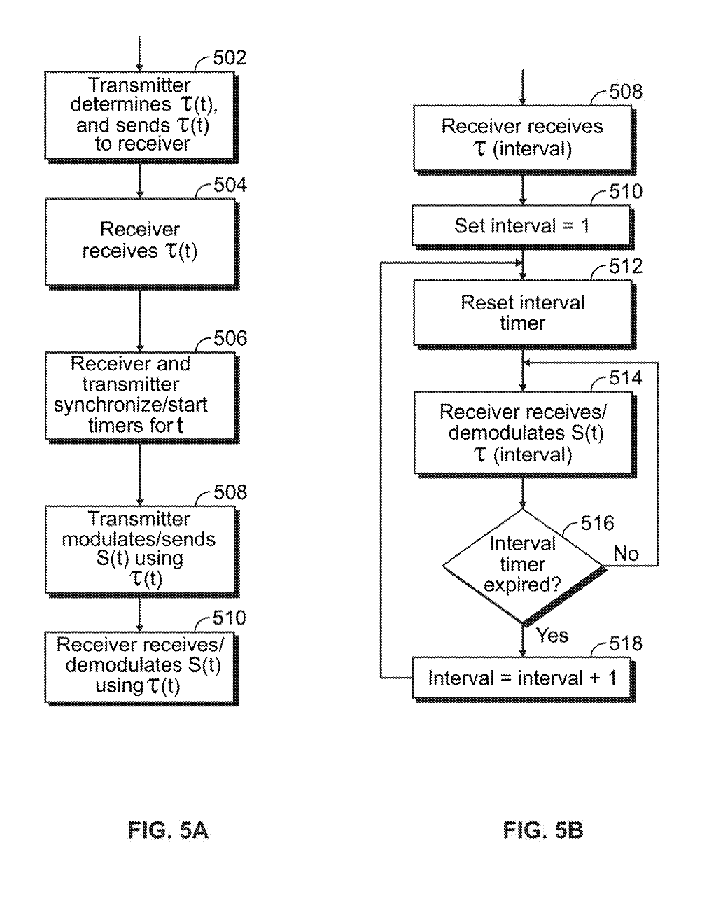

FIG. 5A is a floss diagram illustrating operations performed by another example receiver when receiving a Faster-than-Nyquist multi-carrier signal. The implementation of FIG. 5A may be explained using receiver 101 (of device 102) and transmitter 107 (of base station 106) of FIGS. 1 and 2 as examples of the transmitter and receiver in FIG. 5A.

The process begins at 502 where τ controller 134 of transmitter 107 determines the function τ(t), where τ(t) defined the value of τ to be used in transmitter 107 and receiver 101 over a period of time and sends the function τ(t) to receiver 101. The duration of the time period of τ(t) may be for any length of time. For example, the function τ(t) may define the value of τ to be used by transmitter 107 and receiver 101 over the next X minutes, where the function then may be repeated to determine τ over subsequent periods of X minutes. The function τ(t) may be a continuously varying function or may be a function having discrete values of τ which vary over intervals. For example, τ(t) may be a step function. The function τ(t) may be sent to receiver 101 during setup/initiations of communications.

At 504, receiver 101 receives the function τ(t) that defines values of τ that are to be used by receiver 101 over the relevant time period. The function τ(t) is provided to τ controller 156.

At 506, timer 154 in receiver 101 and timer 135 in transmitter 107 are synchronized and started. Each of timer 154 and timer 135 may be configured to provide a value of τ for τ(t) that is synchronized with a value of t provided by the other. This allows the transmitter 107 and receiver 101 to change the value of τ based on τ(t) so that the same is used in both devices in a synchronized manner.

At 508, transmitter 107 encodes the multi-carrier signal S(t) and sends S(t) to receiver 101. In the embodiment of FIG. 5A, the function of τ 122 may be omitted and source encoder 128 may receive source data 120 directly. Source encoder 128 encodes the source data 120 and provides the source encoded data to channel encoder 130. Channel encoder 130 encodes the data provided by source encoder 128 and provides the channel encoded data to modulator 132. τ controller 134 uses τ(t) and the value of t from timer 135 to determine τ and control modulator 132 to use the appropriate value of τ to modulate S(t) using Faster-Than-Nyquist modulation.

At 510, receiver 101 receives and demodulates S(t). τ controller 156 uses τ(t) and the value of t from timer 154 to determine τ and control demodulator 158 to use the appropriate value of τ to demodulate S(t) using Faster-Than-Nyquist modulation. Because timer 154 is synchronized with timer 135 on transmitter 107), τ controller 156 will use the same value of t that was used by τ controller 134 to modulate S(t). The demodulated S(t) may then be channel decoded in channel decoder 152 and source decoder 150. In the embodiment of FIG. 5A, the function of τ extractor 148 may be omitted and source decoder 150 may provide source data 120 directly to the appropriate application/function on device 102, that is to receive the source data 120 from base station 106.

In an example implementation of the process of FIG. 5A, transmitter 107 and receiver 101 may continue to send and receive the Faster-Than-Nyquist multi-carrier signal S(t) according to τ(t) until communications between transmitter 107 and receiver 101 are terminated. In another example implementation, the process may return to operation 502, periodically or at time intervals, where transmitter 107 may determine an updated function τ(t) and communicate the updated function to receiver 101.

Also, in other implementations of the process of FIG. 5A, the function τ(t) defining the value of τ may be replaced with a function τ(p) defining the value of τ as based on another parameter p that may be dynamically varied. For example, p may represent a value of a parameter such as a bandwidth, a coding scheme, a transmission power, or a number of channels that is dynamically allocated to receiver 102, and may vary during communications on downlink 108.

FIG. 5B is a flow diagram illustrating operations performed by a further example receiver when receiving a Faster-than-Nyquist multi-carrier signal. The implementation of FIG. 5B may he explained using receiver 101 of device 102 as an example of the receiver in FIG. 5B.

The process begins at 508 where receiver 101 receives the function τ(interval) from transmitter 107. The function i(interval) may be a function that defines a value of τ for each of a series of intervals, where, for example, interval=1,2,3, . . . , N. For example, the function τ(interval) may be based on a step function such as the function shown in FIG. 3, where each of τ₁ to τ₆ is defined for a separate interval. The function may be determined at, and sent from, transmitter 107 of base station 106 as described for operation 502 of FIG. 5A.

At 510, τ controller 156 sets the variable interval to 1.

At 512, τ controller 156 starts resets timer 154 to run for an interval period in order to time interval 1. Timer 154 may be set to run for the interval period and multi-carrier signal to τ controller 156 each time an interval expires. The timer 154 may be synchronized with timer 135 in transmitter 107 as described for operation 506 of FIG. 5A.

At 514, receiver 101 receives and decodes S(t). τ controller 156 uses, τ(interval) and the value of interval to determine τ and control demodulator 158 to use the appropriate value of τ to demodulate S(t) using Faster-Than-Nyquist modulation. For example, on the initial pass through 514 interval may be set to 1. Because timer 154 is synchronized with timer 135 on transmitter 107, τ controller 156 will use the same value of interval that was used by τ controller 134 to modulate S(t). The demodulated S(t) may then be decoded in channel decoder 152 and source decoder 150. In the embodiment of FIG. 5A, the function of τ extractor 148 may be omitted and source decoder 150 may provide source data 120 directly to the appropriate application/function on device 102, that is to receive the source data 120 from base station 106.

At 516, τ controller 156 determines if the value of timer 154 indicates that the current interval has expired. If the current interval has not expired the process returns to 514 and receiver 101 continues to receive and decode S(t). τ controller 156 also will continue to check timer 154 at 516 to determine if the interval time has expired.

When it is determined, at 516, that the current interval has expired, the process moves to 518. At 518, the variable interval is incremented by 1 to set interval to the value of the next interval. The process then moves back to 512.

At 512, τ controller 156 resets timer 154 to time the next interval. The process moves to 514, and receiver 101 receives and decodes S(t) with τ controller 156 using τ(interval) and the updated value of interval as set in the last performance of operation 518. τ controller 156 determines τ and controls demodulator 158 to use the appropriate value of τ to demodulate S(t) using Faster-Than-Nyquist modulation. τ controller 156 also will continue to check timer 154 at 516 to determine if the interval time has expired. If it is determined, at 516, that the current interval has expired, the process then again returns to 512. Operations 512, 514, 516 and 518 are then repeated for each subsequent interval. Each time the current interval expires, a new value of interval is generated and a new value of τ for the next interval is determined according to τ(interval).

While the example implementations of FIGS. 2, 4A-4B, and 5A-5B show the determination of the value of τ being performed in one or both of the receiving and transmitting devices of the multi-carrier signal, in other example implementations the determination of the value of τ may be performed in an apparatus such as proxy entity separate from the first or second device. For example, the proxy entity may be implemented as an apparatus configured in infrastructure in the cloud, or as an apparatus included in a server residing on a corporate internet. The apparatus may comprise a network interface, processors, and memory that includes code for controlling the apparatus to determine the acceleration factor based on information associated one or more parameters of the multi-carrier signal between the first and the second device. In an example of this implementation, the CQI determined by the receiver in FIG. 4A may be sent by the receiving device 102 to the proxy entity, or sent to the proxy entity through the base station 106. The proxy entity may then determine an acceleration factor for the multi-carrier signal based on the CQI and provide the acceleration factor to base station 106 and device 102. In another example, the apparatus may also provide information to base station 106 and device 102 related to the structure of the demodulator based on the CQI, such as a trellis state diagram that can be used for decoding the Faster-than-Nyquist multi-carrier. Base station 106 and device 102 may then reconfigure to perform demodulation and modulation according to the information related to the structure of the modulator/demodulator and the acceleration factor received from the apparatus. The apparatus implemented as the proxy entity may also provide any other type of information related to the value of value of τ that may he used by the base station 10 and the device 102, such as a function τ(p) defining the acceleration factor based on p, where p may be any type of parameter. For example, p may indicate the value of a channel parameter, or p may be a time value. Any of the other parameters/methods used for adjusting the value of τ as disclosed in the previous implementations may also be utilized in an implementation where the determination of the acceleration factor is preformed in the proxy entity.

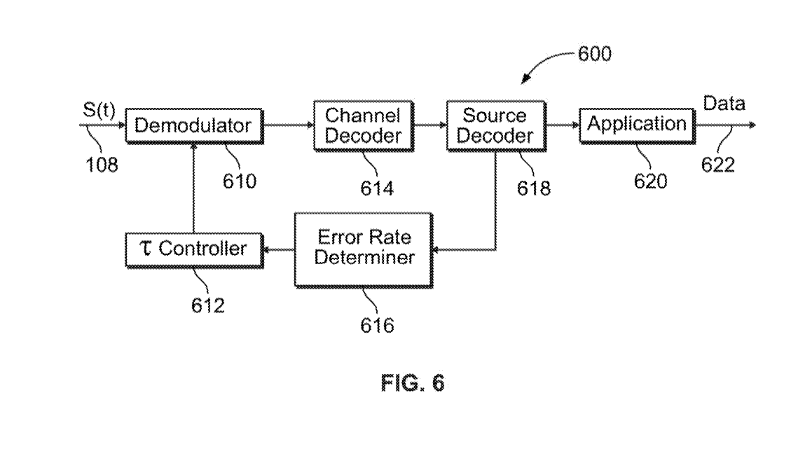

In other implementations, a receiver may be configured to receive a Faster-Than-Nyquist multi-carrier signal modulated by a transmitter using a variable τ without the receiver receiving any indication of the value of τ from the transmitter. FIG. 6 is a block diagram illustrating portions of an example receiver for receiving a Faster-than-Nyquist multi-carrier signal modulated with a variable value of τ. Receiver 600 of FIG. 6 may represent an example implementation of a receiver in device 102 for receiving on the downlink 108 of FIG. 1. Receiver 600 includes demodulator 610, controller 612, error rate determiner 616, channel decoder 614, source decoder 618, and application 620.

In an implementation of FIG. 6, the receiver 600 receives the multi-carrier signal S(t) on downlink 108. Demodulator 610 demodulates S(t) using a value of τ provided by τ controller 612. The demodulated multi-carrier signal is then provided to channel decoder 614 and source decoder 618. Source decoder 618 outputs decoded source data to application 620. Application 620 then outputs data 622 to other appropriate functions on device 102. As source decoder 618 outputs the decoded source data, an error rate of the decoded source data is determined by error rate determiner 616. The error rate may he a packet error rate or a bit error rate that is determined over a time period. Error rate determiner 616 provides an indication of the error rate to τ controller 612. τ controller 612 may then use the indication of the error rate to adjust and control the value of τ that τ controller 612 is providing to demodulator 610.

FIG. 7 is a flow diagram illustrating example operations that may be performed by the receiver of FIG. 6 when receiving a Faster-than-Nyquist multi-carrier signal. FIG. 7 shows an example process where the receiver may receive and demodulate a Faster-Than-Nyquist multi-carrier signal S(t) using different values τ₁, τ₂, τ₃, . . . , τₓ for τ that are determined based on error rate at the receiver. In this example, τ may be dynamically adjusted based on a current error, rate of S(t) at the receiver. Setting τ to the different values of τ₁, τ₂, τ₃, . . . , τₓ based on the error rate allows τ to be adjusted to keep the error rate within an acceptable range.

The process of FIG. 7 also allows a receiver to determine the value of τ to use when a transmitter sends a Faster-Than-Nyquist multi-carrier signal to the receiver and the receiver has no knowledge of the τ being used at the transmitter. In this case the receiver may adjust the value of τ that it uses while initially receiving the multi-carrier signal until the error rate is within an acceptable range. When the error rate is within the acceptable range, the values of τ in the receiver and in the transmitter may be substantially the same or near enough in value for operation with an acceptable error rate.

The process begins at 702 where receiver 600 begins receiving the Faster-Than-Nyquist multi-carrier signal S(t). At 704, τ controller 612 sets the index n to 1. At 706, τ controller 612 sets τ=τₙ. For the initial pass through 706, τ is set to τ₁. The initial value of τₙ when receiver 600 begins receiving S(t) and n=1 may be a default value or a system specified initial value for τ received during setup/initiation of communications with base station 106.

At 708, receiver 600 receives and demodulates S(t) on downlink 108 using the value of τₙ as defined by the current value of n. For example, in the initial pass through 708, τ controller 612 sets τ=τ₁ and controls demodulator 610 to demodulate S(t) using τ₁. The demodulated multi-carrier signal is then decoded in channel decoder 614 and source decoder 618 and provided to application 620.

At 710, as S(t) is received and demodulated, error rate determiner 616 determines the error rate of the source data output from source decoder 618. At 712, error rate determiner 616 determines if the error rate is within an acceptable range of error values. If the error rate is within an acceptable range of error values, the process returns to 708 where receiver 600 continues to receive and demodulate S(t) on downlink 108 using the value of τₙ as defined by the current value of n. If error rate determiner 616 determines that the error rate is not within the acceptable range of error values, the process moves to 713 and error rate determiner 616 provides an indication of the error rate unacceptability to τ controller 612. Upon τ controller 612 receiving an indication that the error rate is not within an acceptable range, the process moves to 714.

At 714, τ controller 612 increments the index n by 1 and at 716, determines a value for τₙ, where n is the value of n as incremented at 710. τ controller 612 determines τₙ based on the error rate that was determined to be out of the acceptable range. For example, if it was determined at 710 that the error rate using τ₁ was not within the acceptable range of error rates, τ₂ is determined at 716. The value for τₙ may be determined as a value that may move the error rate back into the acceptable range of error values used at 710 by error rate determiner 616. For example, if the error is above the acceptable range of values, τ controller 612 may set τₙ to a larger value than the value of τₙ₋₁ to decrease the data rate, and if the error rate is below the acceptable range of values, τ controller 612 may set the value of τₙ to a value smaller than the value of τₙ₋₁ to increase the data rate. The process then moves back to 706. At 706, τ controller 612 sets τ to the value τₙ as determined at 716.

At 708, receiver 600 receives and demodulates S(t) on downlink 108 using τ set at the value of τₙ. Operations 708, 710, and 712 are repeated with τ set at the value τₙ as determined at the last iteration of 716 until the error rate is determined to be outside the acceptable range. When the error rate is determined to be outside of the acceptable range, operations 714 and 716 will be performed to increment n and determine a new value for τ from the value of τₙ, where τₙ is based on the current error rate. The process may repeat using a succession of values τ₁, τ₂, τ₃, . . . , τₓ for τₙ, that are each determined based on a current error rate. Setting τ to the different values of τ₁, τ₂, τ₃, . . . , τₓ allows τ to be adjusted to keep the error rate within an acceptable range.

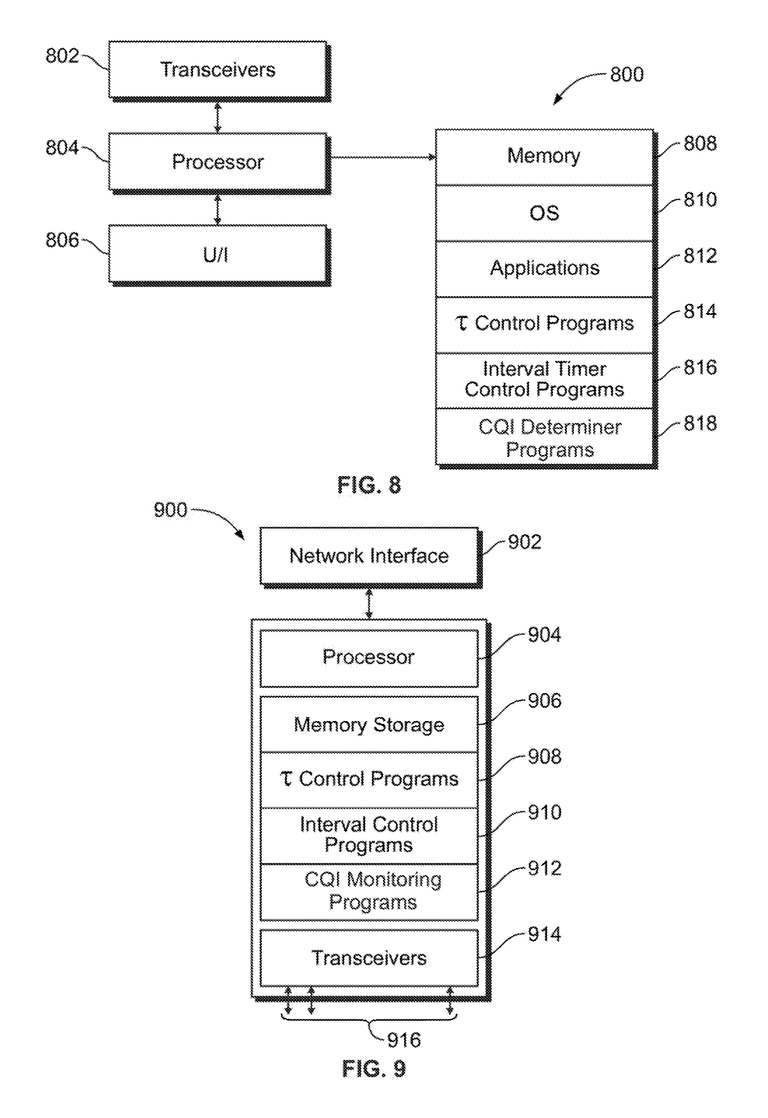

FIG. 8 is a simplified block diagram of an example device 800 that may be implemented to receive a Faster-Than-Nyquist multi-carrier signal. Device 800 represents an example implementation of device 102 of FIG. 1 and FIG. 2, or receiver 600 of FIG. 6. Device 800 includes processor 804, transceivers 802, user interface (UI) 806, and memory/storage 808 that includes code and programs/instructions for applications 812, τ control programs 814, interval timer control programs 816, and channel quality indicator (CQI) determiner programs 818. Memory/storage 808 also includes code and programs/instructions for operating system (OS) 810 that control overall operation of device 800. In an implementation, execution of τ control programs 814, interval timer control programs 816, and channel quality indicator (CQI) determiner programs 818 causes processor 804 to implement operations that cause device 800 to operate to receive a Faster-Than-Nyquist multi-carrier signal modulated using an acceleration factor τ according to the processes of FIG. 4A, FIGS. 5A-5B, or FIG. 7.

FIG. 9 is a simplified block diagram showing an example base station 900 that may be implemented to send a Faster-Than-Nyquist multi-carrier signal. Base station 900 represents a possible implementation of base station 106 of FIG. 1 and FIG. 2. Base station 900 includes processor 904, network interface 902, transceivers 914, and memory storage 906 that includes code and program/instructions for τ control programs 908, interval timer control programs 910, and channel quality indicator (CQI) monitoring programs 912. Base station 900 connects to a backend network over network interface 902.

Network interface 902 may be any type of interface, wireless or otherwise, to a network, for example the internet. Processor 904 may comprise one or more processors, or other control circuitry or any combination of processors and control circuitry that provide overall control of base station 900 according to the disclosed embodiments. Transceivers 914 provide the capability to communicate with devices such as device 102 over channels 916. Memory 906 may be implemented as any type of as any type of computer readable storage media, including non-volatile and volatile memory.

In an implementation, execution of τ control programs 908, interval timer control programs 910, and channel quality indicator (CQI) monitoring programs 912 causes processor 904 to implement operations that cause base station 900 to operate as a transmitting device to send a Faster-Than-Nyquist multi-carrier signal, modulated using an acceleration factor τ according to the processes of FIG. 4B and FIG. 5A, to a receiving device such as device 102.

The example embodiments disclosed herein may be described in the general context of processor-executable code or instructions stored on memory that may comprise one or more computer readable storage media (e.g., tangible non-transitory computer-readable storage media such as memory 808 or 906). As should be readily understood, the terms “computer-readable storage media” or “non-transitory computer-readable media” include the media for storing of data, code and program instructions, such as memory 808 or 906, and do not include portions of the media for storing transitory propagated or modulated data communication multi-carrier signals.

While the functionality disclosed herein has been described by illustrative example using descriptions of the various components and devices of embodiments by referring to functional blocks and processors or processing units, controllers, and memory including instructions and code, the functions and processes of the embodiments may be implemented and performed using any type of processor, circuit, circuitry or combinations of processors and/or circuitry and code. This may include, at least in part, one or more hardware logic components. For example, and without limitation, illustrative types of hardware logic components that can be used include field programmable gate arrays (FPGAs), application specific integrated circuits (ASICs), application specific standard products (ASSPs), system-on-a-chip systems (SOCs), complex programmable logic devices (CPLDs), etc. Use of the term processor or processing unit in this disclosure is mean to include all such implementations.

The disclosed implementations include an apparatus comprising a receiver, one or more processors in communication with the receiver, and memory in communication with the one or more processors, the memory comprising code that, when executed, causes the one or more processors to control the apparatus to receive and demodulate a multi-carrier signal using a first acceleration factor, determine a parameter associated with the demodulated multi-carrier signal, determine if the parameter meets a criteria, and if the parameter meets the criteria, continue to receive and demodulate the multi-carrier signal using the first acceleration factor, or, if the parameter does not meet the criteria, determine a second acceleration factor, and receive and demodulate the multi-carrier signal using the second acceleration factor. The first and second acceleration factors may each comprise a value that determines a number of non-orthogonal pulses of the multi-carrier signal within a time period. The apparatus may determine the first acceleration factor by retrieving the first acceleration factor from the memory. The apparatus may determine the second acceleration factor based at least on the parameter. The apparatus may determine if the parameter meets the criteria by determining if the parameter is within a range of values. The parameter may comprise a channel quality indicator. The parameter may comprise an error rate. The parameter may comprise a first parameter, and the code may be executable, if the value of the first parameter does not meet the criteria, to further cause the one or more processors to control the apparatus to determine a second parameter associated with the multi-carrier signal demodulated using the second acceleration factor, determine if the second parameter meets the criteria, and, if the second parameter meets the criteria, continue to receive and demodulate the multi-carrier signal using the second acceleration factor, or, if the second parameter does not meet the criteria, determine a third acceleration factor, and receive and demodulate the multi-carrier signal using the third acceleration factor.

The disclosed implementations also include an apparatus comprising a receiver, one or more processors in communication with the receiver, and memory in communication with the one or more processors, the memory comprising code that, when executed, causes the one or more processors to control the apparatus to receive information associated with an acceleration factor from a transmitter, determine the acceleration factor based on the information, receive a multi-carrier signal from the transmitter, and demodulate the multi-carrier signal using the acceleration factor. The acceleration factor may comprise a value that determines a number of non-orthogonal pulses of the multi-carrier signal within a nine period. The information may comprise a function defining the acceleration factor based on a parameter and the apparatus determines the acceleration factor as the parameter varies. The information may comprise a function defining the acceleration factor over time and the apparatus determines the acceleration factor as it varies over time. The apparatus may receive the information associated with the acceleration factor from the transmitter during each of a plurality of first time intervals and determine the acceleration factor for each of a plurality of second time intervals, wherein each of the plurality of second time intervals is subsequent to a time interval of the first plurality of time intervals.

The disclosed implementations further include an apparatus comprising a transmitter, one or more processors in communication with the transmitter, and memory in communication with the one or more processors, the memory comprising code that, when executed, causes the one or more processors to control the apparatus to determine information associated with an acceleration factor, send the information to a receiver, modulate a multi-carrier signal using the acceleration factor, and send the modulated multi-carrier signal to the receiver. The acceleration factor may comprise a value that determines a number of non-orthogonal pulses of the multi-carrier signal within a time period. The information may comprise a function defining the acceleration factor based on a parameter and the apparatus may determine the acceleration factor as the parameter varies. The acceleration factor may comprise a first acceleration factor, the information may comprise a value of the first acceleration factor, the apparatus may modulate a first portion of the multi-carrier signal using the first acceleration factor and send the modulated first portion of the multi-carrier signal to the receiver, and the code may be executable to further cause the one or more processors to control the apparatus to receive feedback from the receiver, and determine the value of a second acceleration factor based on the feedback, modulate a second portion of the multi-carrier signal using the second acceleration factor, and send the modulated second portion of the multi-carrier signal to the receiver. The feedback may comprise a channel quality indicator. The information may comprise first information and wherein the code executable to further cause the one or more processors to control the apparatus to send second information associated with the second acceleration factor to the receiver. The apparatus may receive the feedback from the transmitter over a sequence of time intervals.

The disclosed implementations also further include an apparatus comprising at least one interface, one or more processors in communication with the interface, and memory in communication with the one or more processors, the memory comprising code that, when executed, causes the one or more processors to control the apparatus to receive information over the at least one interface, the information associated with at least one parameter of a multi-carrier signal configured for communications between a first and a second device, determine an acceleration factor for the multi-carrier signal based on the at least one parameter, and provide the acceleration factor to at least one of the first and the second device. The code may be executable to further cause the one or more processors to control the apparatus to determine information associated with a structure for demodulation of the multi-carrier signal based on the at least one parameter, and provide the information associated with the structure to at least one of the first and the second device. The information associated with the structure may comprise information associated with a trellis structure.

Although the subject matter has been described in language specific to structural features and or methodological acts, it is to be understood that the subject matter defined in the appended claims is not necessarily limited to the specific features or acts described above. Rather, the specific features and acts described above are disclosed as example embodiments, implementations, and forms of implementing the claims and these example configurations and arrangements may be changed significantly without departing from the scope of the present disclosure. Moreover, although the example embodiments have been illustrated with reference to particular elements and operations that facilitate the processes, these elements, and operations may be combined with or, be replaced by, any suitable devices, components, architecture or process that achieves the intended functionality of the embodiment. Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. An apparatus comprising:
a receiver;
one or more processors in communication with the receiver; and,
memory in communication with the one or more processors, the memory comprising code that, when executed, causes the one or more processors to control the apparatus to:
receive and demodulate a multi-carrier signal using a first acceleration factor;
determine a parameter associated with the demodulated multi-carrier signal;
determine if the parameter meets a criteria; and,
if the parameter meets the criteria:
continue to receive and demodulate the multi-carrier signal using the first acceleration factor;
or, if the parameter does not meet the criteria;
determine a second acceleration factor; and,
receive and demodulate the multi-carrier signal using the second acceleration factor.

2. The apparatus of claim 1, wherein the first acceleration factor comprises a first number of non-orthogonal pulses of the multi-carrier signal within a first time period and the second acceleration factor comprises a second number of non-orthogonal pulses of the multi-carrier signal within a second time period.

3. The apparatus of claim 1, wherein the first acceleration factor is determined by retrieving the first acceleration factor from the memory.

4. The apparatus of claim 1, wherein the second acceleration factor is based on the parameter.

5. The apparatus of claim 1, wherein the apparatus determines if the parameter meets the criteria by determining if the parameter is within a range of values.

6. The apparatus of claim 1, wherein the parameter comprises a channel quality indicator.

7. The apparatus of claim 1, wherein the parameter comprises an error rate.

8. The apparatus of claim 1, wherein the parameter comprises a first parameter, and the code is executable, if the value of the first parameter does not meet the criteria, to further cause the one or more processors to control the apparatus to:
determine a second parameter associated with the multi-carrier signal demodulated using the second acceleration factor;
determine if the second parameter meets the criteria; and,
if the second parameter meets the criteria:
continue to receive and demodulate the multi-carrier signal using the second acceleration factor;
or, if the second parameter does not meet the criteria;
determine a third acceleration factor; and,
receive and demodulate the multi-carrier signal using the third acceleration factor.

9. An apparatus comprising;
a receiver;
one or more processors in communication with the receiver; and,
memory in communication with the one or more processors, the memory comprising code that, when executed, causes the one or more processors to control the apparatus to;
receive information associated with an acceleration factor from a transmitter;
determine the acceleration factor based on the information;
receive a multi-carrier signal from the transmitter; and,
demodulate the multi carrier signal using the acceleration factor.

10. The apparatus of claim 9, wherein the acceleration factor comprises a value that determines a number of non-orthogonal pulses of the multi-carrier signal within a time period.

11. The apparatus of claim 9, wherein the information comprises a function defining the acceleration factor based on a parameter and the apparatus determines the acceleration factor as the parameter varies.

12. The apparatus of claim 9, wherein the information comprises a function defining the acceleration factor over time and the apparatus determines the acceleration factor as it varies over time.

13. The apparatus of claim 9, wherein the apparatus receives the information associated with the acceleration factor from the transmitter during each of a plurality of first time intervals and determines the acceleration factor for each of a plurality of second time intervals, wherein each of the plurality of second time intervals is subsequent to a time interval of the first plurality of time intervals.

14. An apparatus comprising:
a transmitter;
one or more processors in communication with the transmitter; and,
memory in communication with the one or more processors, the memory comprising code that, when executed, causes the one or more processors to control the apparatus to:
determine information associated with an acceleration factor;
send the information to a receiver;
modulate a multi-carrier signal using the acceleration factor; and,
send the modulated multi-carrier signal to the receiver.

15. The apparatus of claim 14, wherein the acceleration factor comprises a value that determines a number of non-orthogonal pulses of the multi-carrier signal within a time period.

16. The apparatus of claim 14, wherein the information comprises a function defining the acceleration factor based on a parameter and the apparatus determines the acceleration factor as the parameter varies.

17. The apparatus of claim 14, wherein the acceleration factor comprises a first acceleration factor, the information comprises a value of the first acceleration factor, the apparatus modulates a first portion of the multi-carrier signal using the first acceleration factor and sends the modulated first portion of the multi-carrier signal to the receiver, and the code is executable to further cause the one or more processors to control the apparatus to:
receive feedback from the receiver;
determine the value of a second acceleration factor based on the feedback;
modulate a second portion of the multi-carrier signal using the second acceleration factor; and,
send the modulated second portion of the multi-carrier signal to the receiver.

18. The apparatus of claim 17, wherein the feedback comprises a channel quality indicator.

19. The apparatus of claim 17, wherein the information comprises first information and wherein the code is executable to further cause the one or more processors to control the apparatus to send second information associated with the second acceleration factor to the receiver.

20. The apparatus of claim 17, wherein the apparatus receives the feedback from the transmitter over a sequence of time intervals.

21. An apparatus comprising:
at least one interface;
one or more processors in communication with the interface; and,
memory in communication with the one or more processors, the memory comprising code that, when executed, causes the one or more processors to control the apparatus to:
receive information over the at least one interface, the information associated with at least one parameter of a multi-carrier signal configured for communications between a first and a second device;
determine an acceleration factor for the multi-carrier signal based on the at least one parameter; and,
provide the acceleration factor to at least one of the first and the second device.

22. The apparatus of claim 20, wherein the code is executable to further cause the one or more processors to control the apparatus to:
determine information associated with a structure for demodulation of the multi-carrier signal based on the at least one parameter; and,
provide the information associated with the structure to at least one of the first and the second device.

23. The apparatus of claim 21, wherein the information associated with the structure comprises information associated with a trellis structure.

24. The apparatus of claim 20, wherein the acceleration factor comprises a value that determines a number of non-orthogonal pulses of the multi-carrier signal within a time period.
